(19) United States
(12) Patent Application Publication
(10) Pub. No.: US 2002/0175452 A1
(43) Pub. Date: Nov. 28, 2002

(54) Sliding gate plating structure

(75) Inventor: Koji Kawarada, Kariya-city (JP)

Correspondence Address: FOLEY AND LARDNER, SUITE 500, 3000 K STREET NW, WASHINGTON, DC, 20007, US

(73) Assignee: TOSHIBA CERAMICS CO., LTD.

(21) Appl. No.: 10/047,037

(22) Filed: Jan. 17, 2002

(30) Foreign Application Priority Data
May 23, 2001 (JP) 2001-153421

(51) Int. Cl. B67D 3/00; C21C 5/42

(52) U.S. Cl. 266/236; 266/272

(57) ABSTRACT

The present invention provides a sliding gate plating structure where formation and growth of cracks in a fire-resistant plate are restrained such that the service life and the safety of the sliding gate are improved.

The present invention uses a sliding gate plating structure formed with a fire-resistant plate 1 provided with a raised portion in cross-section and an opening section 1b bored the through a raised portion 1a to extend in the direction of thickness, a hoop 2 fitted to an outer periphery 1c of said plate 1 by way of shrink fitting, a mortar 3 covering at least part of an outer periphery 1d of said raised portion 1a and an upper surface 1e of the plate and an integrated steel can 4 set to cover said outer periphery 1d of the raised portion, the upper surface 1e of the plate and the outer periphery 1c of the plate.

### BACKGROUND OF THE INVENTION

1. Field of the Invention

The present invention relates to a sliding gate plating structure and more particularly to a sliding gate plating structure fitted to a sliding gate controlling the flow of liquid metal flowing from a liquid metal container such as a ladle, a tundish or the like.

2. Description of the Related Art

In the process of steel making or molding, the flow of liquid metal is controlled by the sliding gate when the liquid metal flows out from the liquid metal container such as the ladle, the tundish or the like.

This sliding gate is mounted to the bottom of the liquid metal container and normally provided with a fixed plate made of a fire-resistant material with a circular opening bored therethrough and a sliding plate adapted to slide on said fixed plate and having an opening similar to that of said fixed plate such that the liquid metal flow is controlled by sliding said sliding plate on the fixed plate to bring the openings of both plates into or out of register.

For such sliding gate, a two-layered type with two fire-resistant plates or a three-layered type with three fire-resistant plates is normally used.

For example, in the two-layered type sliding gate as shown in FIG. 3, said two fire-resistant plates include a fixed plate 21 formed with an upwardly raised portion 21a as seen in cross section with an opening 21b bored therethrough to extend in the direction of thickness and a sliding gate 22 attached to the bottom surface of said fixed plate 21 and formed with a downwardly raised portion 22a as seen in cross section with an opening 22b bored therethrough to extend in the direction of thickness.

The liquid metal flow is controlled by sliding said sliding plate 22 on the fixed plate 21 to make the opening 21b and the opening 22b into or out of register such that the opening and closing action of the flow in/out port of the liquid metal is performed.

Also, in the three-layered type sliding gate as shown in FIG. 4, said three fire-resistant plates include a fixed plate 31 formed with an upwardly raised portion 31a in cross section and having an opening 31b bored therethrough to extend in the direction of thickness, a flat sliding gate plate 33 kept in contact with the bottom surface of said fixed plate 31 and having an opening 33b bored therethrough to extend in the direction of thickness and a fixed plate 32 kept in contact with the bottom surface of said sliding gate plate 33 and formed with a downwardly raised portion 32a in cross-section having an opening 22b bored therethrough to extend in the direction of thickness.

The liquid metal flow is controlled by sliding said sliding plate 33 on the fixed plate 31 to bring the opening 31b, the opening 32b and the opening 33b into or out of register such that the opening and closing action of the flow in/out port of the liquid metal is performed.

Here, in said two-layered type or three-layered type sliding gate, the whole or part thereof of the fire-resistant plate except the sliding surface being wound with a steel band is in wide use from the viewpoint of the prevention of cracks in the plate or the measurement accuracy.

Although not shown in the drawings, an upper surface of said sliding gate is secured to a metal frame provided at the bottom section of the liquid metal container. Methods for securing the same include a method which pushes a damper held in contact with a corner of said fire-resistant plate and then fasten it with a bolt and a method which drives a cotter or the like to secure the same.

Also, in the sliding gate having a structure in which said fire-resistant plate is wound with a steel band, the methods used for securing the plate inside the metal frame include (1) a method of securing said raised portion, (2) a method of securing by use of a magnet and (3) a method of securing by use of a cam or the like.

The conventional sliding gate adopting the methods (1), (2) or (3) as a means of securing has an integral steel can including a fire-resistant plate with an integral steel can set thereon, said integral steel can having a thickness of approximately 1 to 3 mm in view of the required measurement accuracy and the nature of the way of fastening. Said integral steel can set on the fire-resistant plate is shown in FIG. 5.

FIGS. 5(a) and 5(b) show equivalents of the fixed plate 21 of FIG. 3 or the upper fixed plate 31 of FIG. 4, FIG. 5(a) and FIG. 5(b) additionally showing the integrated steel can 43 set thereonto. FIG. 5(a) is a plan view and FIG. 5(b) is a C-C cross-sectional view of FIG. 5(a) taken along the line C-C therein. Thus, the plate of FIGS. 5 (a) and 5 (b) shown in cross section includes a fire-resistant plate 41 formed with a raised portion 41a in cross section having an opening 41b bored therethrough to extend in the direction of thickness, a mortar 42 covering a periphery of said upwardly raised portion 41a and an outer periphery of said fire-resistant plate 41 and an integral steel can 43 set to cover the surface of said mortar 42.

Here, at the time of discharging the liquid metal in a process of molding or the like, the liquid metal having a temperature of 1500° C. through 1650° C. passes through the opening formed in the fire-resistant plate such that the whole of the sliding gate plating including the fire-resisting plate is heated up to a high temperature as a result of thermal conduction therethrough.

However, at a temperature of approximately 1000° C., the coefficient of thermal expansion of the fire-resistant plate is 0.6 to 1.0% whereas that of the steel can is approximately 1.2% to indicate that there is a difference between the two members. Therefore, the conventional sliding plating structure as mentioned above tends to have a reduced fastening effect of the integral steel can intended to secure the fire-resistant plate by way of the mortar due to the overall temperature rise after a long hour operation.

Then, as the fastening effect of the fire-resistant plate within the integrated steel can becomes unstable, cracks are formed in the fire-resistant plate because of a thermal shock at the beginning of molding or a mechanical external force inflicted by the sliding of the plate and there is a technical problem that such cracks grows.

Also, it is to be noted that the material to be used for said fire-resistant plate are selected from an alumina carbon matter, a magnesia carbon matter or a magnesia spinel matter or the like depending on a type of the liquid metal and a use of the molding. Of said materials, the above magnesia type matter having a relatively large coefficient of thermal expansion is more likely to cause cracks and as the cracks grow to such an extent that the plate is split, there is a risk of causing a serious accident by the leak of liquid metal.

### SUMMARY OF THE INVENTION

The present invention is made to solve above-mentioned technical problems and it is an object of the invention to provide a sliding gate plating structure where the formation and growth of cracks in a fire-resistant plate are restrained such that the service life and the safety of the sliding gate are improved.

A sliding gate plating structure in accordance with the present invention comprises a fire-resistant plate formed with a raised portion in cross-section and an opening bored therethrough a raised portion to extend in the direction of thickness, a hoop fitted to an outer periphery of said plate by way of shrink fitting, a mortar covering at least part of an outer periphery of said raised portion and an upper surface of said fire-resistant plate and an integrated steel can set to cover said outer periphery of the raised portion, the upper surface of the plate and the outer periphery of the plate.

The sliding gate plating structure described above provides a fastening effect peculiar to a shrink fitted hoop such that the growth of cracks is restrained and also the service life and the safety of the sliding gate are improved.

Further, in addition to a reinforcement effect of the fire-resistant plate by securing of the shrink fitted plate, the integrated steel can and the hoop that are screwed together are both made of steel such that thermal properties such as the coefficients of thermal expansion are similar and therefore screwed status of two is prevented from becoming unstable by a thermal shock.

It is preferred that the thickness of said hoop is 3 to 12 mm and the thickness of the steel member of said integrated steel can is 1 to 3 mm which is thinner than the thickness of said hoop.

With the above-mentioned structure, the synergism of a securing effect by said shrink fitted hoop and a durability of the screwing power between the hoop and the integrated steel can is brought about while the growth of cracks in the fire-resistant plate is prevented effectively, and therefore it is suitable for long term use of the sliding gate.

Also, another sliding gate plating structure in accordance with the present invention comprises a fire-resistant plate formed with a raised portion in cross-section and having an opening bored therethrough to extend in the direction of thickness, a hoop fitted to an outer periphery of said plate by way of shrink fitting, a mortar covering an outer periphery of said raised portion, a steel nib member covering the outer periphery of said raised and an steel plate covering said upper surface of the plate.

The sliding gate plating structure described above provides said fastening effect by the shrink fitted hoop and also the separate provision of the hoop, the steel plate and the nib steel member to insure that the manufactured sliding gate plating is able to match with variety of shapes and the cost for manufacturing the sliding gate plating is able to be reduced sharply.

### BRIEF DESCRIPTION OF THE DRAWINGS

FIG.1(a) and FIG.1(b) are schematic illustration showing one embodiment of the sliding gate plating structure according to the present invention wherein FIG.1(a) is a plan view and FIG.1(b) is an A-A cross-sectional view of FIG.1(a) taken along the line A-A therein;

FIG. 2(a) and FIG. 2(b) are schematic illustration showing another embodiment of the sliding gate plating structure according to the present invention wherein FIG. 2(a) is a plan view and FIG. 2(b) is a B-B cross-sectional view of FIG. 2(a) taken along the line B-B therein;

FIG. 3 is a schematic cross-sectional view showing one example of the conventional two-layered sliding gate;

FIG. 4 is a schematic cross-sectional view showing one example of the conventional three-layered sliding gate; and

FIG. 5(a) and FIG. 5(b) are schematic illustration showing another embodiment of the sliding gate plating structure according to the present invention wherein FIG. 5(a) is a plan view and FIG. 5(b) is a C-C cross-sectional view of FIG. 5(a) taken along the line C-C therin.

### DESCRIPTION OF THE PREFERRED EMBODIMENTS

The present invention will be described specifically hereinafter with reference to the drawings.

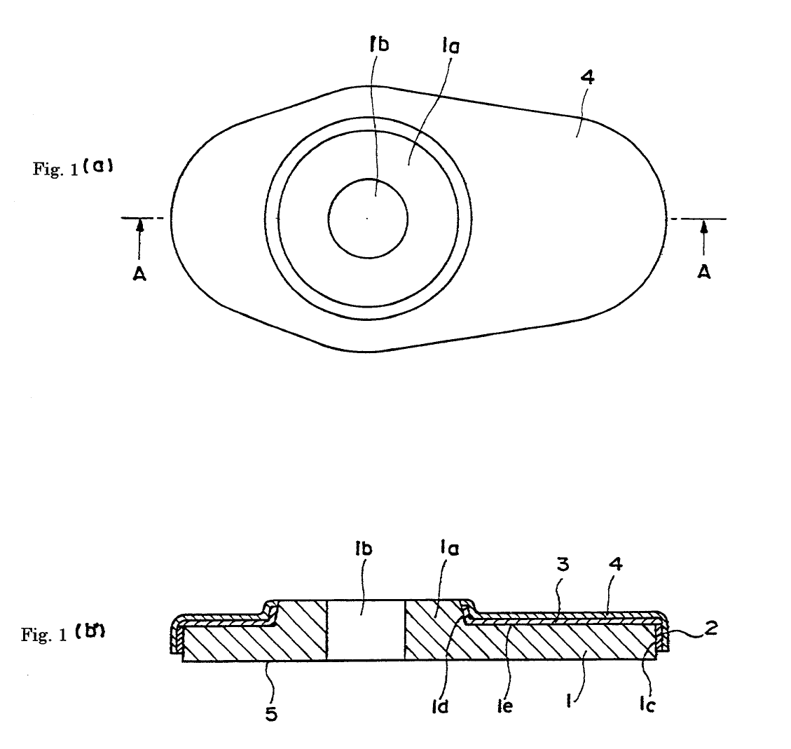

FIG.1(a) and FIG.1(b) show one embodiment of the sliding gate plating structure according to the present invention wherein FIG.1(a) is a plan view and FIG.1(b) is an A-A cross-sectional view of FIG.1(a) taken along the line A-A therin.

As shown in FIG.1(a) and FIG.1(b), a sliding gate plating structure in accordance with the present invention is composed of a fire-resistant plate 1 formed with a raised portion 1a as seen in cross section having an opening 1b bored therethrough to extend in the direction of thickness, a hoop 2 fitted to an outer periphery 1c of said plate 1 by way of shrink fitting, a mortar 3 covering at least part of an outer periphery 1d of said raised portion 1a and the upper surface 1e of the plate and an integrated steel can 4 set to cover said outer periphery 1d of the raised portion, the upper surface 1e of the plate and the outer periphery 1c of the plate by way of said mortar 3.

To manufacture said sliding gate plating structure, the fire-resistant plate 1 formed with the raised portion 1a in cross-section and the opening 1b bored therethrough to extend in the direction of thickness is prepared. After the hoop (steel band) 2 is heated to expand to be fitted around the outer periphery 1c of the fire-resistant plate 1, said hoop 2 is allowed to stand until the same cools to closely fit through contraction and form so-called shrink fitted hoop 2.

The mortar 3 is then applied to at least part of the periphery 1d of said raised portion and the upper surface 1e of the plate. Next, an inner surface of the integrated steel can 4 is fitted to the outer periphery of said hoop 2 while said mortar 3 is brought into close contact with an inner surface of said integrated steel can to be united by heating.

Then, by working the surface opposite the raised portion 1a of said fire-resistant plate 1 with a grinding step to form a sliding surface 5, a sliding gate plating structure is completed.

The material used for said fire-resistant plate is selected properly in accordance with a type of the liquid metal and a use of the molding. For example, an alumina carbon matter, a magnesia carbon matter or a magnesia spinel matter or the like are used as such material.

The sliding gate plating structure according to the present invention is effective in preventing the formation and growth of cracks within said fire-resistant plate even in the case of using the magnesia type matter whose coefficient of thermal expansion is relatively high and subject to the so-called spalling.

Also, the shape of the outer periphery of the fire-resistant plate is not limited to the above shape and it is able to use an oval shaped plate or a polygon shaped plate or the like.

Moreover, the fire-resistant plate is able to be manufactured by a normal process and for example by adding a dispersing agent and a hardener or the like to a slurry which is prepared from a fire-resistant material powder, then after a compound made by aforementioned process goes through the steps of mixing, molding and drying, the compound is baked to obtain the fire-resistant plate.

The hoop used in the present invention has a similar shape to the outer periphery of the fire-resistant plate and has a circumferential length of an inner surface made slightly shorter than the circumferential length of the outer periphery of said fire-resistant plate taking into consideration of the coefficients of thermal expansion.

Although the condition of the shrink fitting of said hoop is set properly in accordance with a service condition of the sliding gate or the material of the fire-resistant matter, the shrink fitting of the hoop is normally conducted at a temperature of 500° C. through 1000° C.

Also, although the thickness of said hoop is set properly in accordance with the size of the plate, the service condition of the sliding gate or the material of the fire-resistant matter, it is preferred that the thickness of the hoop is thicker than the thickness of said integrated steel can and within a range of 3 to 12 mm and more particularly within a range of 3 to 9 mm.

And the height of said hoop is normally set less than the thickness of the outer periphery of the fire-resistant plate.

Moreover, the integrated steel can used in the present invention covers the outer periphery of the raised portion, upper surface of the plate and the outer periphery of the plate to be secured to said fire-resistant plate. As described above, the integrated steel can is secured integrally to the fire-resistant plate by way of mortar.

The integrated steel can with the thickness of from 1 to 3 mm is preferably used. When the thickness of said integrated steel can is more than 3 mm, said integrated steel can is likely to be separated from the mortar when subjected to the thermal shock, the distortion at the time of sliding movement or the like because of the hardness. On the other hand, when the thickness of the steel can is less than 1 mm, the power to secure the integrated steel can to said hoop weakens such that the loosening is likely to occur after the long term use and be damaged by the thermal shock or the like at the time of use.

Moreover, the mortar is applied to at least part of the periphery of the raised portion of the fire-resistant plate and the upper surface of the plate. For example, as shown in FIG.1, the mortar is applied to all the surface of the outer periphery of the raised portion 1d and the upper surface le of the plate. This mortar 3 is used to secure the fire-resistant plate 1 and the integrated steel can 4 integrally as described above.

By the way, when the mortar is applied to only part of the periphery of the raised portion of the fire-resistant plate and the upper surface of the plate, it is able to secure the fire-resistant plate 1 and the integrated steel can 4 integrally in the same manner as described above.

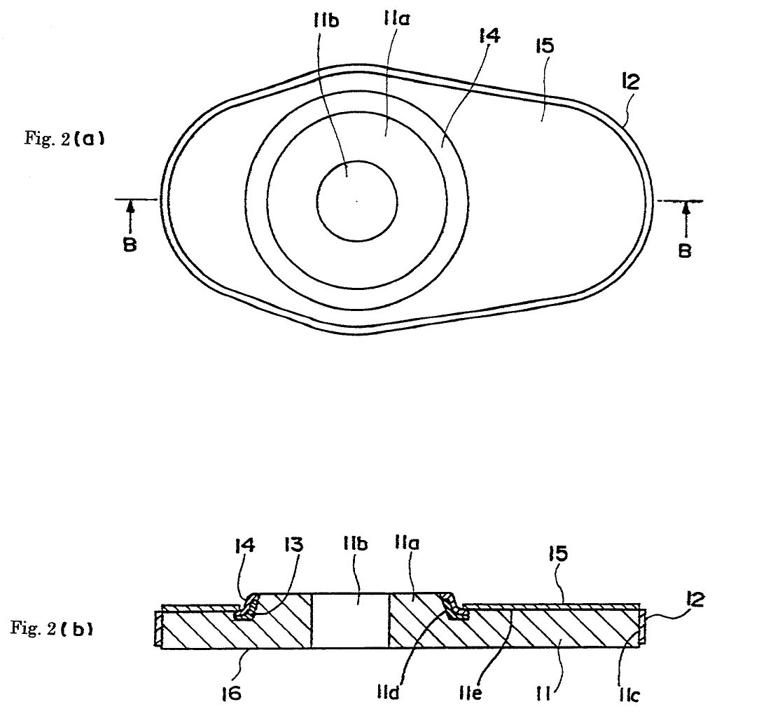

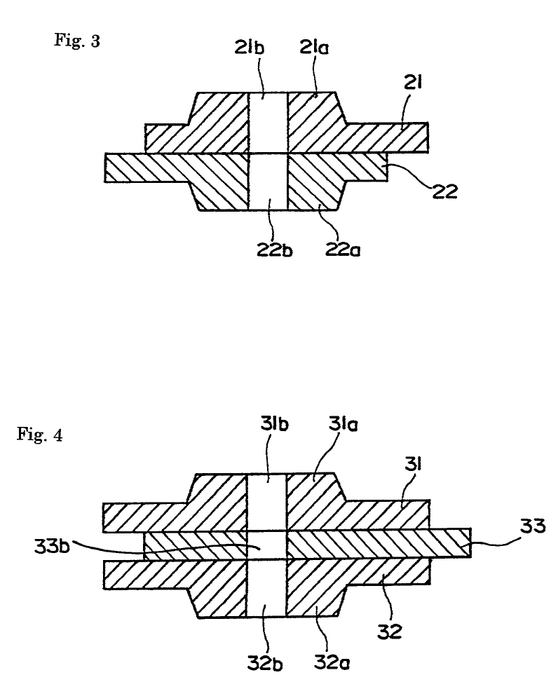

Next, another embodiment of the sliding gate plating structure according to the present invention will be described based on FIG. 2(a) and FIG. 2(b). Here, FIG. 2(a) is a plan view of said another embodiment and FIG. 2(b) is a B-B cross-sectional view of FIG. 2(a) taken along the line B-B therin.

This sliding gate plating structure is composed of a fire-resistant plate formed with a raised portion 11a in cross-section having an opening 11b bored therethrough to extend in the direction of thickness, a hoop 12 fitted to an outer periphery 11c of said plate 11 by way of shrink fitting, a mortar 13 covering an outer periphery lid of said raised portion 11a, a steel nib member 14 covering the outer periphery 11d of said raised portion and an steel plate 15 covering said upper surface 11e of the plate.

While the hoop 12 is fitted to the outer periphery 11c of the fire-resistant plate 11 which is formed similarly to the sliding gate shown in FIG. 1, the steel nib member 14 and the steel plate 15 are used in FIG. 2 in the place of the integrated steel can 4 used in FIG. 1.

Because the hoop 12, the steel plate 15 and the steel nib member 14 are formed separately, it is able to manufacture the sliding gate plating which matches with variety of shapes and the cost for manufacturing the sliding gate plating is reduced sharply as compared with the integrated steel can in which the steel portions are formed integrally.

By the way, the steel nib member 14 and the steel plate 15 are joined by way of welding while the hoop 12 and the steel 15 are joined similarly by way of welding.

To manufacture this sliding gate plating, as described above, a fire-resistant plate 11 formed with a raised portion 11a in cross-section and having an opening 11b bored therethrough to extend in the direction of thickness is first prepared. And then, the hoop (steel band) 12 is heated to expand to be fitted around the outer periphery 11c of the fire-resistant plate 11 and, then, allowed to stand until the same cools to closely fit with contraction and form the so-called shrink fitted hoop 12.

The steel nib member is then fitted to the outer periphery 11d of said raised portion by way of mortar 13 and the steel plate 15 is fitted to the upper surface 11e of the plate by welding the same to the steel nib member 14 such that the steel plate 15 covers the upper surface 11e of the plate.

Then, the sliding gate plating is completed by working the surface opposite the raised portion 11a of said fire-resistant plate 11 with a grinding step to finish a sliding surface 16.

Although the thickness of said hoop, said steel nib member and said steel plate are set properly in accordance with the shape of the fire-resistant plate, it is preferred that the thickness of said hoop is from 3 to 12 mm and the thickness of said steel nib coating and said steel plate are 1 to 3 mm such that they are thinner than the thickness of said hoop.

With the above-described structure, a sufficient effect of securing by use of shrink fitted hoop is obtained similarly to the above-described case where the integral steel can is used. It is also possible to produce the sliding gate plating with a measurement which permits the same to be fitted properly to a metal frame formed in the bottom of the liquid metal container and also matches with variety of shapes and the cost for manufacturing the sliding gate is able to be reduced sharply.

By the way, while the fixed plate in the form of the upper member of the sliding gate plating has so far been described, the fixed plate in the form of the lower member of the sliding gate is able to be constructed in the same manner.

### [EXAMPLES]

The present invention will be described more specifically with reference to the examples hereinafter. However, the present invention is not limited to the examples described below.

### [Example 1]

A fire-resistant plate made of magnesia carbon matter was used to manufacture a sliding gate plating structure as shown in FIG. 1.

Said sliding gate plating structure was mounted to a steel manufacturing ladle weighing 110 tons to conduct a bearing testing using an actual machine in which a molten steel (steel type: SS400) of 1550° C. through 1600° C. flows out from the sliding gate three times for 70 to 75 minutes at a time.

### [Example 2]

A fire-resistant plate similar to the example 1 was used to manufacture a sliding gate plating structure as shown in FIG. 2. Similarly to Example 1, said sliding gate plating structure was mounted to the ladle to conduct the bearing testing using the actual machine.

### [Comparative Example 1]

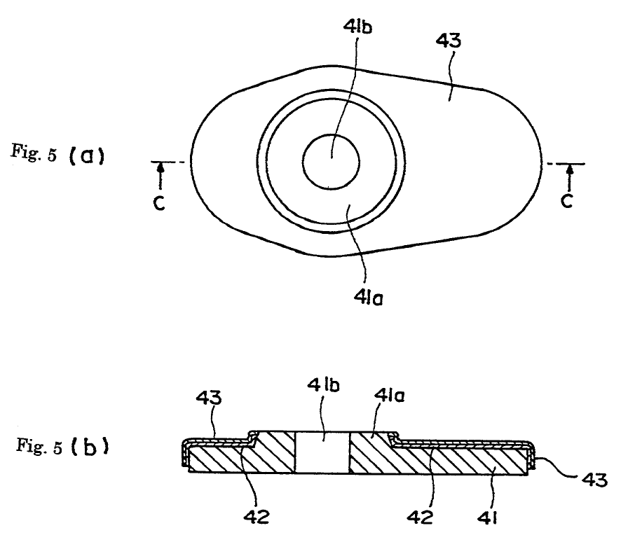

A fire-resistant plate similar to the Example 1 was used to manufacture a sliding gate plate as shown in FIG. 5. Similarly to Example 1, said sliding gate plating was mounted to the ladle to conduct the bearing testing using the actual machine.

The result of said bearing testing shows the conventional sliding gate plate (Comparative Example 1) has a problem that if the flow-out of the molten steel was performed twice, cracks were formed in the fire-resistant plate and said cracks grew when the flow-out of the cast was performed once more.

In contrast to the conventional sliding gate plating, the sliding gate plating structure according to the present invention (Example 1 and Example 2) in which the shrink fitted hoop is provide, the formation of cracks in the fire-resistant plate was very little and there was no significant changes in the external appearance when the flowing out of the molten steel was performed three times and also the sliding at the time of opening and closing of the slide gate was smooth.

As described above, the sliding gate plating structure according to the present invention is able to obtain a unique fastening effect by the combination of the shrink fitted hoop and the steel can (steel member) by mortar joining. As a result, the formation and growth of cracks on the fire-resistant plate is controlled and the life and the safety is improved that long-term use is available.

Also, in the present invention, the sliding gate plating structure with an outstanding accuracy of dimension can be obtained easily.

What is claimed is:

1. A sliding gate plating structure comprising
a fire-resistant plate formed with a raised portion in cross-section and having an opening bored therethrough to extend in the direction of thickness;
a hoop fitted to an outer periphery of said plate by way of shrink fitting;
a mortar covering at least part of an outer periphery of said raised portion and an upper surface of the plate; and
an integrated steel can set to cover said outer periphery of the raised portion, the upper surface of the plate and the outer periphery of the plate.

2. A sliding gate plating structure as set forth in claim 1 wherein a thickness of said integrated steel can is set thinner than a thickness of said hoop.

3. A sliding gate plating structure comprising
a fire-resistant plating provided with a raised portion in cross-section and having an opening bored therethrough to extend in the direction of thickness;
a hoop fitted to an outer periphery of said plate by way of shrink fitting;
a mortar covering an outer periphery of said raised portion;
a steel nib member covering the outer periphery of said raised portion; and
an steel plate covering said upper surface of the plate.
